(19) United States
(12) Patent Application Publication
(10) Pub. No.: US 2010/0150783 A1
(43) Pub. Date: Jun. 17, 2010

(54) CHEMICAL REACTION APPARATUS

(75) Inventors: Muneki ARARAGI, Musashino-shi (JP); Takeo TANAAMI, Musashino-shi (JP); Nobuyuki KAKURYU, Musashino-shi (JP); Masakatsu NOGUCHI, Musashino-shi (JP)

Correspondence Address: SUGHRUE MION, PLLC, 2100 PENNSYLVANIA AVENUE, N.W., SUITE 800, WASHINGTON, DC, 20037, US

(73) Assignee: YOKOGAWA ELECTRIC CORPORATION, Musashino-shi (JP)

(21) Appl. No.: 12/713,259

(22) Filed: Feb. 26, 2010

Related U.S. Application Data
(62) Division of application No. 11/839,666, filed on Aug. 16, 2007.

(30) Foreign Application Priority Data
Aug. 22, 2006 (JP) 2006-225502

(51) Int. Cl. B01J 19/00; G05B 1/00

(52) U.S. Cl. 422/105; 422/119

(57) ABSTRACT

A chemical reaction apparatus in which a chemical reaction of solutions is carried out by transferring the solutions includes moving units to seal or move the solutions in a flow passage or a plurality of chambers of a container by applying an external force to an elastic body of the container by moving on a surface of the elastic body while the moving units contact with the surface of the elastic body, the moving units being movable independently from each other with respect to a cartridge including the container which is at least partially structured with the elastic body, the container including the plurality of chambers to contain the solutions and the flow passage to connect the plurality of chambers, and a detection unit to detect a state of solution pool in the flow passage or the chamber.

This application is a divisional of U.S. Ser. No. 11/839,666, filed Aug. 16, 2007, which claims priority to JP 2006-225502, filed Aug. 22, 2006, each of which is hereby incorporated by reference in its entirety.

### BACKGROUND OF THE INVENTION

1. Field of the Invention

The present invention relates to a chemical reaction apparatus capable of automatically carrying out a chemical reaction such as a mixing, a synthesis, dissolution, and a separation of a solution.

2. Description of the Related Art

Conventionally, a test tube, a beaker, a pipette, and the like are generally used for processes such as a synthesis, dissolution, detection, a separation, or the like of a solution. For example, a substance A and a substance B are collected in the test tubes or the beakers in advance, these substances are injected into other container which is a test tube or a beaker, and a substance C is prepared by mixing/agitating the mixture of substances A and B. Concerning the substance C synthesized in such way, for example, a light emission, a heat generation, coloration, a colorimetry, and the like are observed. Alternatively, in some cases, filtration, a centrifugal separation, or the like is carried out for the mixed substance, and a targeted substance is separated and extracted.

Moreover, glassware such as a test tube, a beaker, or the like is also used in a dissolution process which is a process of dissolving a substance by an organic solvent, for example. Similarly in case of a detection process, a test substance and a reagent are introduced in a container and the reaction result is observed.

As such a chemical reaction cartridge described abode, there is known a cartridge in which a plurality of reaction chambers that can swell in a front surface side of an elastic body and flow passages that connect the plurality of reaction chambers to one another are formed on a back surface of the elastic body, and in which a substrate is provided on the back surface of the elastic body so as to hermetically seal the reaction chambers and the flow passages (for example, see JP2005-037368A). Concerning the above chemical reaction cartridge, solutions are injected into the reaction chambers in advance, the flow passages, the reaction chambers, or both thereof is partially blocked by pressing a roller from the front surface side of the elastic body, and the solutions in the flow passages or the reaction chambers move. In such way, the solutions react.

JP2005-037368A proposes a method of transferring the solution in the container by applying a pressure by a roller from the front surface side of the elastic body. Meanwhile, an automatic transferring of the solution is being attempted. In such case, it is required that the solution be surely moved from the solution chamber or the flow passage and that a fictitious transfer and a solution transfer error be prevented. In particular, in case of measuring and testing a valuable sample or a rare sample, a failure due to a solution transfer error is impermissible. Therefore, a highly reliable drive mechanism for solution transfer which prevents the solution transfer error and the fictitious transfer is required. Further, the cartridge is pressurized by being pushed with the roller in order to apply an external force to the cartridge. However, when the cartridge is pressurized in the position displaced from the proper position, the external force varies due to irregularity of the front surface of the cartridge and a thickness unevenness of the cartridge. As a result, there has been a problem in which the solution transfer error and the fictitious transfer occur.

### SUMMARY OF THE INVENTION

In view of the above problem, an object of the present invention is to provide a chemical reaction apparatus capable of surely preventing the solution transfer error and the fictitious transfer, and capable of realizing a highly reliable solution transfer and an automation of the solution transfer.

In accordance with a first aspect of the present invention, a chemical reaction apparatus in which a chemical reaction of solutions is carried out by transferring the solutions comprises moving units to seal or move the solutions in a flow passage or a plurality of chambers of a container by applying an external force to an elastic body of the container by moving on a surface of the elastic body while the moving units contact with the surface of the elastic body, the moving units being movable independently from each other with respect to a cartridge including the container which is at least partially structured with the elastic body, the container including the plurality of chambers to contain the solutions and the flow passage to connect the plurality of chambers, and a detection unit to detect a state of solution pool in the flow passage or the chamber.

Preferably, the chemical reaction apparatus further comprises a control unit to drive the moving units and transfer the solutions by moving the moving unit again on the surface of the elastic body where the state of solution pool is detected when the state of solution pool is detected by the detection unit.

Preferably, the detection unit comprises a light emitting unit to emit a light to the solutions in the plurality of chambers or the flow passage and a light receiving unit to receive a reflection light reflected from the solutions by emitting the light, a transmitted light, or a fluorescent.

Preferably, the detection unit comprises a light emitting unit to emit a light to the solutions in the plurality of chambers or the flow passage and an image detection unit to detect an image of the solutions, which is formed by emitting the light as an image signal.

Preferably, a light guide path which communicates with inside of the plurality of chambers or the flow passage is formed in the cartridge, and the light emitted by the light emitting unit is detected by the image detection unit after passing through the light guide path and being introduced in the plurality of chambers or the flow passage.

Preferably, the detection unit comprises an ultrasonic oscillation unit to oscillate an ultrasonic wave to the solutions in the plurality of chambers or the flow passage and an ultrasonic receiving unit to receive the ultrasonic wave which is oscillated from the solutions due to the ultrasonic wave being oscillated by the ultrasonic oscillation unit.

In accordance with a second aspect of the present invention, a chemical reaction apparatus in which a chemical reaction of solutions is carried out by transferring the solutions comprises an external force applying unit to move the solutions in a flow passage or a plurality of chambers of a container by applying an external force to an elastic body of the container by moving on a surface of the elastic body while the external force applying unit contacts with the surface of the elastic body with respect to a cartridge including the container which is at least partially structured with the elastic body, the container including the plurality of chambers to contain the solutions and the flow passage to connect the plurality of chambers, and an elastic coefficient of the external force applying unit in a direction in which the external force is applied to the cartridge is smaller than an elastic coefficient of the corresponding cartridge.

Preferably, the elastic coefficient of the cartridge is not less than 1.1 times the elastic coefficient of the external force applying unit.

Preferably, the external force applying unit stands between moving units which move while the moving units contact with the surface of the elastic body and an apparatus body which supports the moving units so as to move freely, and the external force applying unit is at least one of a spring, rubber, or an elastromer for assuring the elastic coefficient, or at least one of a member for generating a magnetic force, a member for generating an air pressure, or a piezoelectric element.

Preferably, a pressurization force is measured by a pressure sensor and an applied voltage to the piezoelectric element is changed, when the piezoelectric element is used for the external force applying unit.

According to the present invention, a state of solution pool is detected by the detection unit, and the solution in the area where the solution pool is detected is retransferred by the moving unit. Thereby, the solution transfer error and the fictitious transfer can be surely prevented, and the highly reliable solution transfer and the automation of the solution transfer can be realized. Moreover, the chemical reaction apparatus of the present invention includes a suspension mechanism between the moving units and the apparatus body in order to solve the problem that the external force varies due to the irregularities of the cartridge surface and the thickness unevenness of the cartridge when the solution transfer is driven by applying the external force to the cartridge.

### BRIEF DESCRIPTION OF THE DRAWINGS

The present invention will become fully understood from the detailed description given hereinafter and the accompanying drawings given by way of illustration only, and thus are not intended as a definition of the limits of the present invention, wherein:

FIG. 1A is a perspective view of a cartridge 3;

FIG. 1B is a top view of the cartridge 3;

FIG. 1C is a cross-sectional view cut along a plane line I-I of FIG. 1B;

FIG. 2 is a diagram showing a chemical reaction apparatus 100 wherein a portion of the cartridge 3 is a cross-sectional view simulating a state of liquid transfer;

FIG. 3A is a perspective view of an outer appearance of a first squeegee 41 in case where a coil springs 61 are used;

FIG. 3B is a perspective view of an outer appearance of the first squeegee 41 in case where a plate spring 64 is used;

FIG. 4A is a modification example of a detection unit, which is a plan view showing the cartridge 3 and the squeegees 41 and 42;

FIG. 4B is a modification example of the detection unit, which is across-sectional view cut along a line IV-IV of FIG. 4A;

FIGS. 5A to 5C are diagrams showing operations of the first to third squeegees 41 to 43 wherein the portions of the cartridges 3 are the cross-sectional views simulating the state of liquid transfer;

FIGS. 6A to 6C are plan views showing the operations of the first to third squeegees 41 to 43;

FIG. 7 is a sectional side view showing operations of the first to third squeegees 41 to 43 when a solution pool occurs;

FIG. 8 is a sectional side view showing a state before the first to third squeegees 41A to 43A operate;

FIGS. 9A to 9C are diagrams showing operations of the first to third rollers 141 to 143, and cartridges 13 are cross-sectional views wherein the portions of the cartridges 3 are the cross-sectional views simulating the state of liquid transfer;

FIG. 10A is a perspective view of an outer appearance of the first roller 141 in case where coil springs 146 are used; and

FIG. 10B is a perspective view of an outer appearance of the first roller 141 in case where a plate spring 149 is used.

### PREFERRED EMBODIMENT OF THE INVENTION

Hereinafter, embodiments of the present invention will be described with reference to the drawings.

### First Embodiment

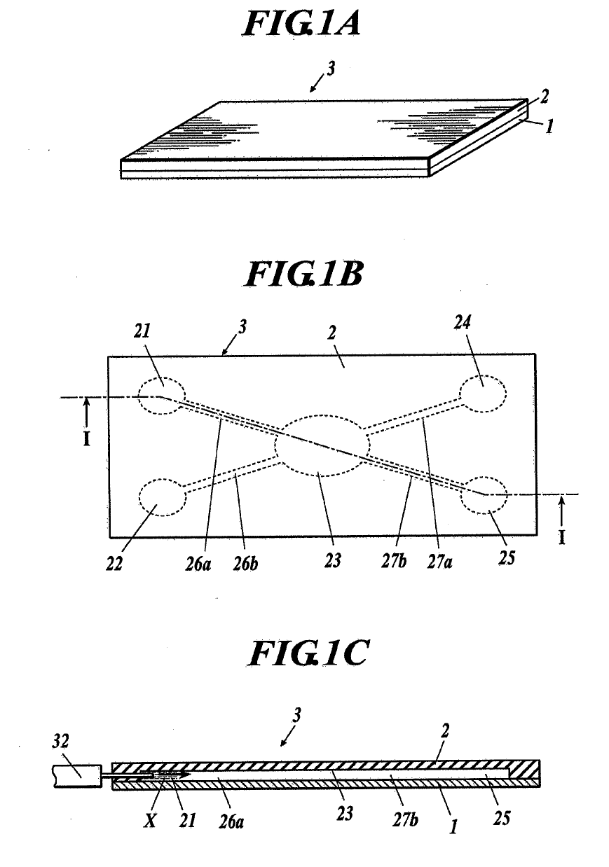

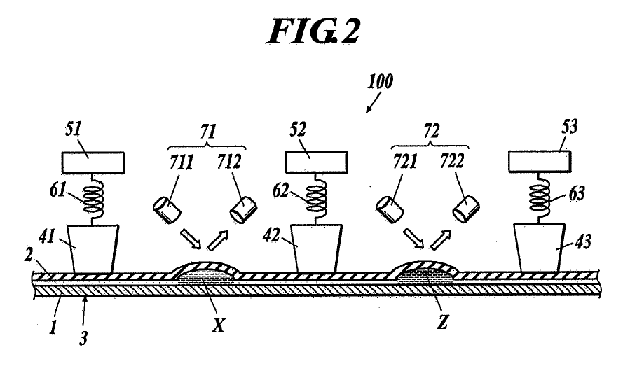

FIG. 1A is a perspective view of a cartridge 3. FIG. 1B is a top view of the cartridge 3. FIG. 1C is a cross-sectional view cut along a line I-I of FIG. 1B. FIG. 2 is a cross-sectional view cut along the line I-I of FIG. 1B, showing a chemical reaction apparatus 100.

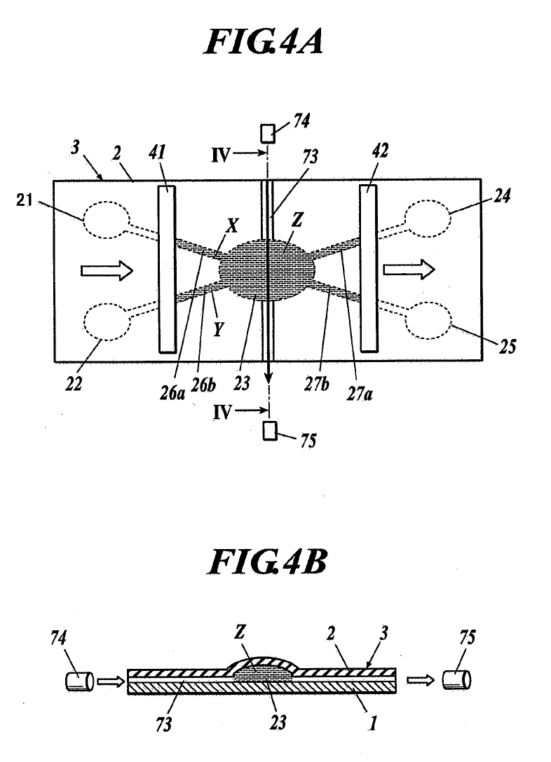

In the chemical reaction apparatus 100, a container is composed by providing an elastic body 2 on a substrate 1 in a stacking manner. The chemical reaction apparatus 100 comprises a cartridge 3, a plurality of squeegees (hereinafter, called the first squeegee 41, the second squeegee 42, and the third squeegee 43) (moving units), and detection sensors (detection units) 71 and 72. The cartridge 3 is composed by forming a plurality of chambers 21 to 25 in which solutions X and Y (see FIG. 4) are contained and flow passages 26a, 26b, 27a and 27b which connect the chambers 21 to 25 to one another between the substrate 1 and the elastic body 2. The first to third squeegees 41 to 43 apply an external force to the elastic body 2 to partially block the flow passage 26a, 26b, 27a, and 27b, the chambers 21 to 25, or both thereof and move the solutions X and Y in the blocked flow passages 26a, 26b, 27a, and 27b or the chambers 21 to 25 by moving on an upper surface of the elastic body 2 while contacting thereto. The detection sensors 71 and 72 detect the states of solution pools of the solutions X, Y and Z present in the flow passages 26a, 26b, 27a and 27b or the chambers 21 to 25. Moreover, the chemical reaction apparatus 100 comprises a control unit which transfers the solutions by driving the first to third squeegees 41 to 43 to move on the upper surface of the elastic body 2 in the area where the solution pools have occurred again when the states of solution pools are detected by the detection sensors 71 and 72.

The substrate 1 is made with a hard material to give resistance toward the external force applied from the elastic body 2, and is formed in a long flat shape to house the chambers 21 to 25 and flow passages 26a, 26b, 27a, and 27b for realizing the reaction protocol, to determine the position, and to maintain the shape.

The elastic body 2 is made with a silicon rubber such as PDMA (polydimethylsiloxane) or the like or a polymeric material which is airtight and has elasticity, and is formed in a long flat shape in a same size as the substrate 1. The elastic body 2 may be made with a viscoelastic body or a plastic body other than rubber. A plurality of recessed units for the solutions which respectively can dent and swell in the upper surface side of the elastic body 2 are formed on a lower surface of the elastic body 2 which is a contact surface with the substrate 1. The plurality of recessed units become injection chambers 21 and 22 for injection in which the solutions are to be injected, a reaction chamber 23 for reaction unit in which the solutions in the injection chambers 21 and 22 react, and dispense chambers 24 and 25 for dispensing in which the solution reacted in the reaction chamber 23 is to be dispensed. Further, the flow passages 26a and 26b which respectively connect the injection chambers 21 and 22 with the reaction chamber 23 and the flow passages 27a and 27b which respectively connect the dispense chambers 24 and 25 with the reaction chamber 23 are formed on the lower surface of the elastic body 2. The injection chambers 21 and 22 and the dispense chambers 24 and 25 are in a circular shape in a plan view, and the reaction chamber 23 is in an oval shape in a plan view. Further, an adhered area of the lower surface of the elastic body 2 which excludes the injection chambers 21 and 22, the reaction chamber 23, the dispense chambers 24 and 25, and the flow passages 26a, 26b, 27a, and 27b is adhered to an upper surface of the substrate 1. In such way, the injection chambers 21 and 22, the reaction chamber 23, the dispense chambers 24 and 25, and the flow passages 26a, 26b, 27a, and 27b are hermetically sealed by the elastic body 2 and the substrate 1, and thereby leakage of the after-mentioned solutions X, Y, and Z is prevented.

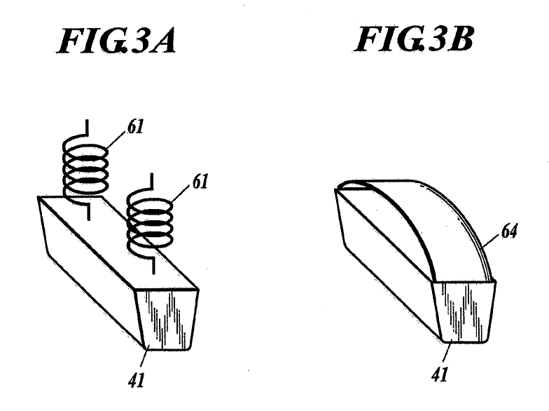

FIG. 3A is a perspective view of an outer appearance of the first squeegee 41. The first to third squeegees 41 to 43 are rectangular columns which form a trapezoidal shape when seen from the side, in which an upper surface is larger than a lower surface, and the first to third squeegees 41 to 43 are extended along a short side direction of the cartridge 3. Further, the squeegees 41 to 43 may have an R portion which is chamfered to reduce the contact resistance to the elastic body 2. The first to third squeegees 41 to 43 are arranged in a plurality of lines in a longitudinal direction of the cartridge 3 (see FIG. 2), and the first to third squeegees 41 to 43 are to move independently on the upper surface of the elastic body 2 while contacting thereto. The first to third stages 51 to 53 which support each of the squeegees 41 to 43 onto the upper surface of the elastic body 2 so as to respectively move freely are provided above the first to third squeegees 41 to 43. The first to third stages 51 to 53 are attached to the apparatus body (omitted from the drawing).

The first to third stages 51 to 53 are extended along each of the squeegees 41 to 43. In order to stably apply an appropriate external force to the cartridge 3 regardless of irregularities and thickness unevenness of the cartridge 3, the first to third squeegees 41 to 43 and the first to third stages 51 to 53 are respectively connected with the springs (external force applying unit) 61 to 63 which are retractable in an up-down direction. Upper ends of the springs 61 to 63 are respectively fixed to both ends of a lower surface of each of the stages 51 to 53, and lower ends of the springs 61 to 63 are respectively fixed to both ends of an upper surface of each of the squeegees 41 to 43. In such way, the first to third squeegees 41 to 43 can move on the upper surface of the elastic body 2 with a consistent pressure while contacting thereof by the springs 61 to 63. Concerning the springs 61 to 63, the elastic coefficient of the direction in which the external force is applied to the cartridge 3 is preferably smaller than the elastic coefficient in the cartridge 3 side, and desirably, the elastic coefficient of the cartridge 3 is not less than 1.1 times the elastic coefficient of the springs 61 to 63.

Moreover, a plate spring 64 which extends along a longitudinal direction of the squeegee 41 as shown in FIG. 3B may be used for the springs 61 to 63 other than coiled springs.

The detection sensors 71 and 72 are, for example, disposed at a part in which an important reaction is carried out or at an upstream portion or a downstream portion of the above-described part among the flow passages 26a, 26b, 27a, and 27b or the plurality of chambers 21 to 25, and the states of solution pools are detected. As shown in FIG. 2, the detection sensors 71 and 72 are provided between the first squeegee 41 and the second squeegee 42 and between the second squeegee 42 and the third squeegee 43 in the embodiment.

For example, the detection sensors 71 and 72 comprising light sources (light emitting units) 711 and 721, such as LEDs (light emitting diodes), LDs (semiconductor lasers), or the like, which emit light to the flow passages 26a, 26b, 27a, and 27b or the plurality of chambers 21 to 25, and photodiodes (light receiving units) 712 and 722 which receive the light reflected by the solutions in the flow passages 26a, 26b, 27a, and 27b or the chambers 21 to 25 due to the light being emitted are suggested. The states of solution residual of the solutions are detected by detecting the change in amount of reflected light.

Moreover, although it is omitted from the drawing, the detection units 71 and 72 may comprise a light source (light emitting unit) which emits light by LED or LD, and the CCD array sensors, or the CMOS array sensors (image detection unit) which detect the image pattern which is formed by the solution in the flow passages or the chambers. In such case, the states of solution residual of the solutions are detected from the change in the image pattern. Further, the light used for the light source may be visible light, and the light which emits in the near infrared area or the infrared area may be used in a case where the elastic body 2 and the substrate 1 made with a material which is opaque in the visible region are used.

Further, the detection sensor 71 and 72 may comprise an ultrasonic oscillation element (ultrasonic oscillation unit) such as a piezoelectric element or the like which emits the ultrasonic wave to the solutions in the flow passages or the chambers, and an ultrasonic receiving element (ultrasonic receiving unit) which detects the reflected signal from the solutions. In such case, the states of solution residual of the solutions may also be detected form the change in the reflected signal.

FIG. 4 is an example of other detection unit, and FIG. 4A is a plan view showing the cartridge 3 and the squeegees 41 and 42 and FIG. 4B is across-sectional view cut along a line IV-IV. As shown in FIGS. 4A and 4B, the elastic body 2 and the substrate 1 are formed with transparent material, a light guide path 73 is formed by forming a portion of the elastic body 2 or the substrate 1 with a material having different refractive index, a light source (for example, LED, LD, or the like) 74 is provided at the light incidence side of the light guide path 73, a light detector (for example, light receiving element such as the CCD array, the PD, or the like) 75 is provided at the light outgoing side of the light guide path 73, and the light from the light source 74 is to enter the light guide path 73 and the change in amount of light passing through the light guide path 73 is detected by the light detector 75. In such case, the amount of light passing the solution differs when there is a solution pool in the light guide path 73. Therefore, the states of solution pool can be detected from the change in the amount of light. In the case of FIG. 4, the light guide path 73 if formed along the short side direction of the cartridge 3 so as to communication with the reaction chamber 23. The place in which the light guide path 73 is formed is not limited to the reaction chamber 23, and may be formed along the short side direction of the cartridge 3 so as to communicate with the flow passages 26a and 26b and the flow passages 27a and 27b.

When it is difficult to form the light guide path 73, the change in the amount of light may be detected in the same manner as the case described above by implanting the fiber optics in the elastic body 2 or the substrate 1 (omitted from the drawing).

The control unit controls the entire chemical reaction apparatus 100. Particularly, the control unit starts the driving of the first to third stages 51 to 53, transfers the solution by moving the first to third squeegees 41 to 43 due to the moving of the first to third stages 51 to 53, and stops the driving of the first to third stages 51 to 53 when the solution transfer is completed. Further, the control unit detects whether the solution pool due to the solution transfer error has occurred or not by the detection signal from the detection sensor 71 and 72 from time to time during the solution transfer, and stops the solution transfer by stopping the first to third stages 51 to 53 when the solution pool has occurred. After the control unit makes the stage which is in the place where the solution pool has occurred is moved to the original position, the control unit retransfers the solution by moving the squeegee in the direction of solution transfer again. Here, the control unit controls the driving of the squeegees so that the other squeegees press and hold the upper surface of the elastic body 2.

Next, the solution transfer operation in the chemical reaction apparatus 100 will be described.

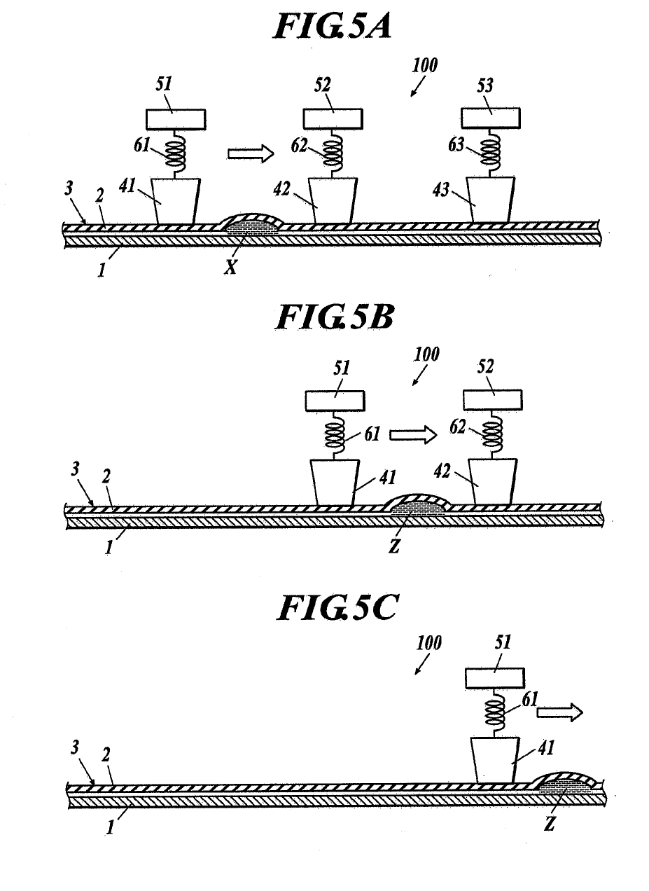

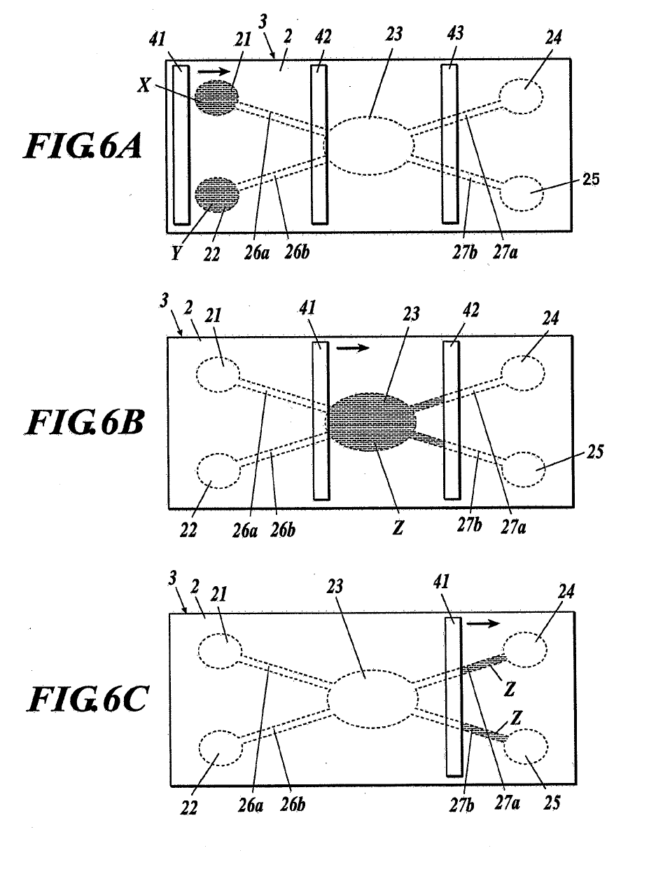

FIGS. 5 and 6 are diagrams showing an embodiment of the chemical reaction cartridge according to the present invention. FIGS. 5 and 6 describe a portion of the movement in which the plurality of squeegees are disposed in a predetermined interval, and are synchronized and move sequentially to transfer the solution. FIGS. 5A, 5B, and 5C are diagrams showing the movement of the first to third squeegees 41 to 43. The portions of the cartridges 3 are cross sectional views simulating the state of liquid transfer. FIGS. 6A to 6C are plan views showing the movement of the first to third squeegees 41 to 43. Here, the detection sensors 71 and 72 are omitted from FIGS. 5 and 6 for the sake of the arrangement of the drawings.

First, the solutions X and Y are respectively injected into the injection chambers 21 and 22 shown in FIG. 1B which are formed in the cartridge 3 in advance. The injection of the solutions is carried out by, for example, directly sticking a needle 32 in the elastic body 2 as shown in FIG. 1C, and the solutions are injected in the injection chambers 21 and 22 by the needle 32. The hole made by the needle will close by itself because the elastic body 2 is formed with an elastic material. In order to completely seal the hole made by the needle, an adhesive agent or the like may be injected in the hole or the hole may be heated and dissolved to be sealed after the solutions are injected,

FIGS. 5A and 6A show that state after the solutions X and Y are injected and before the solution transfer. The first squeegee 41 is positioned at a left end of the upper surface of the elastic body 2, and a lower surface of the first squeegee 41 is squeezing the elastic body 2 by contacting the upper surface of the elastic body 2 by the predetermined pressurization. From this state, the first stage 51 moves to the right side from the left side, and thereby the first squeegee 41 moves to the right side along the upper surface of the elastic body 2 at the same time. Here, the solutions X and Y which are contained in the injection chambers 21 and 22 are pushed out in the right direction and move to the reaction chamber 23 through the flow passages 26a and 26b while the upper surface of the elastic body 2 is being squeezed by the lower surface of the first squeegee 41 under the predetermined pressurized state by the action of the spring 61.

As shown in FIGS. 5B and 6B, the first stage 51 moves a predetermined distance and comes to the position where the second stage 52 was positioned and at the same time, the second squeegee 42 moves along the upper surface of the elastic body 2 in a similar manner due to the second stage 52 moving in the right side to the position of the third stage 53. Then, the solutions X and Y which are transferred into the reaction chamber 23 are mixed and the reaction occurs. Here, reaction means, for example, a mixing, a synthesis, dissolution, a separation, and the like. By using the cartridge 3 in the above described manner, for example, dioxine, DNA, and the like are detectable. Further, the first squeegee 41 is pressing the upper surface of the elastic body 2 at this time, and thereby, the backflow of the transferred solution is prevented.

As shown in FIGS. 5C and 6C, when the first stage 51 moves a predetermined distance and comes to the position where the third stage 53 was positioned, the solution Z which has reacted in the reaction chamber 23 is divided and move into the flow passages 27a and 27b. Further, the third state 53 is driven and moves in the right side and the same time, the third squeegee 43 moves along the upper surface of the elastic body 2. Thereby, the reacted solution Z moves to the dispense chambers 24 and 25 from the flow passages 27a and 27b. At this time, the first squeegee 41 is pressing the upper surface of the elastic body 2 and thereby, the backflow of the transferred solutions is prevented.

Meanwhile, during the above-mentioned series of the solution transfer operation, the detection sensors 71 and 72 detect whether the solution pool has occurred or not from time to time, and the movement of the first to third stages 51 to 53 is stopped when the solution pool has occurred. Further, the squeegee which positions at the place where the solution pool has occurred is separated from the cartridge 3 and moves to the original position along with the stage. Then, retransfer of the solution is carried out by the squeegee due to the squeegee moving in the direction of solution transfer again. At this time, the squeegees in both sides press and hold the upper surface of the elastic body 2 and thereby, the solutions flowing out to the targeted region is prevented.

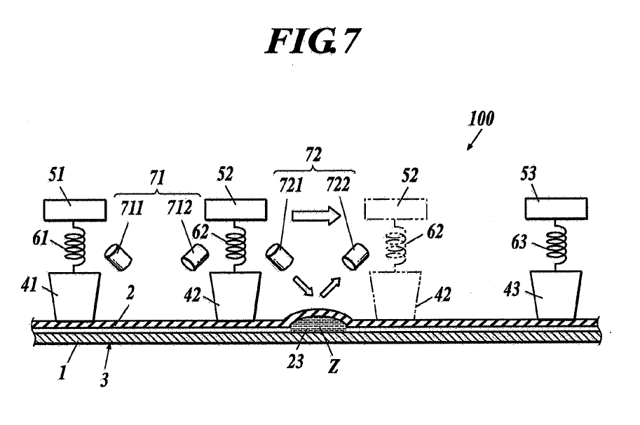

Particularly, as shown in FIG. 7, the second squeegee 42 moves on the upper surface of the elastic body 2 in a state of holding the solutions X and Y so that the solutions will not flow backward or forward and retransfer of the solution is carried out due to the first squeegee 41 and the third squeegee 43 located at both sides of the second squeegee 42 pressing the upper surface of the elastic body 2 when the solution pool has occurred at the position of the second squeegee 42, for example. The first squeegee 41 and the third squeegee 43 function as check valves.

As described above, the chemical reaction apparatus comprises the plurality of squeegees 41 to 42 and the plurality of stages 51 to 53 which move freely, being independent from one another while contacting the upper surface of the elastic body 2, and the detection sensors 71 and 72 which detect the states of solution pool occurred in the flow passages 26a, 26b, 27a, and 27b or in the chambers 21 to 25. When the solution pool has occurred, the solution pool is automatically detected by the detection sensor 71 and 72, and retransfer of the solution is carried out by moving the squeegee 42 on the upper surface of the elastic body 2 at the place where the solution pool is detected. Therefore, the solution transfer error and the fictitious transfer can be prevented, and the solutions can be surely transferred to carry out the reaction, As a result, a highly reliable solution transfer can be realized. Further, it is efficient because the detection of the solution pool and the retransfer of the solution are carried out automatically and not manually.

Moreover, the springs 61 to 63 are respectively provided between the first to third squeegees 41 to 43 and the first to third stages 51 to 53. Therefore, the flexure and irregularity of the elastic body 2 are absorbed by the springs 61 to 63 and each squeegees 41 to 43 can be pressed on to the upper surface of the elastic body 2 with a proper pressure even in a case where the force adjustment on the pressurized surface is uneven due to the flexure, irregularity, and thickness unevenness of the elastic body 2. Thus, in this respect, the highly reliable solution transfer can also be realized.

### Second Embodiment

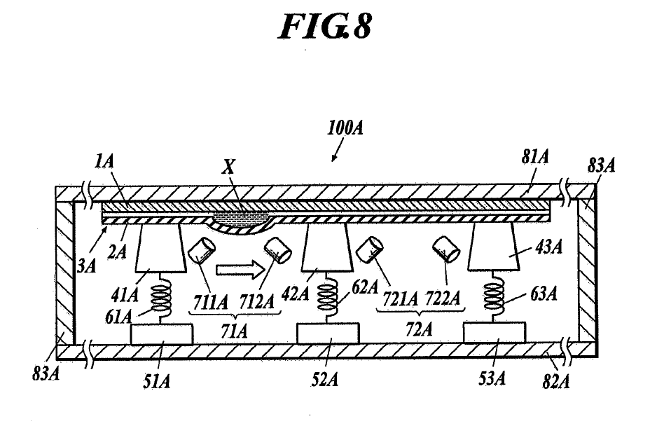

FIG. 8 is a sectional side view showing a state before the first to third squeegees 41A to 43A operate.

Differently from the chemical reaction apparatus 100 of the first embodiment described above, a cartridge 3A is attached facing downward in a chemical reaction apparatus 100A of the present embodiment, and it is constructed so that the first to third squeegees 41A to 43A move on a lower surface of the cartridge 3A. Here, the cartridge 3A, the first to third squeegees 41A to 43A, and the first to third stages 51A to 53A are same as the cartridge 3, the first to third squeegees 41 to 43, and the first to third stages 51 to 53 of the first embodiment. Therefore, the same components are indicated with the same numbers with an alphabet A, and the descriptions are omitted.

As shown in FIG. 8, a top plate 81A and a bottom plate 82A are facing each another, and the top plate 81A and the bottom plate 82A are supported by side plates 83A and 83A which are vertically arranged at both left and right ends of the top plate 81A and the bottom plate 82A. The cartridge 3A is attached on a lower surface of the top plate 81A, and the first to third stages 51A to 53A are provided on an upper surface of the bottom plate 82A so as to independently move freely in a left-right direction. The first to third squeegees 41A to 43A and the first to third stages 51A to 53A are respectively connected by three springs 61A to 63A. The first to third squeegees 41A to 43A can move on a lower surface of an elastic body 2A while contacting thereto by a predetermined pressurization by the springs 61A to 63A. Further, concerning the springs 61A to 63A, the elastic coefficient of the direction in which the external force is applied to the cartridge 3A is preferably smaller than the elastic coefficient of the cartridge 3, and the elastic coefficient of the cartridge 3A is desirably not less than 1.1 times the elastic coefficient of the springs 61A to 63A. This is because, thereby, the irregularity of the elastic body 2A can be absorbed and the proper pressure can be applied to the elastic body 2A.

Moreover, similarly to the detection sensors 71 and 72 in the first embodiment, detection sensors 71A and 72A are provided at predetermined positions.

In addition, the chemical reaction apparatus 100A comprises a control unit which controls so as to start and stop the driving of the first to third stages 51A to 53A, and which controls the first to third squeegees 41A to 43A so as to carry out retransferring of the solution when the occurrence of the solution pool is detected by detecting whether the solution pool has occurred or not from the detection result by the detection sensors 71A and 72A during the solution transfer.

The solution transfer is carried out in a similar manner as in the case of the first embodiment. Here, the plan diagram showing the movement of the first to third squeegees 41A to 43A is omitted for the sake of the arrangement of the drawings. However, the plan view of the movement of the first to third squeegees 41A to 43A is basically the same as FIG. 6.

The first squeegee 41A which positions at a left end of the lower surface of the elastic body 2A is made to move in a right side while contacting on the lower surface of the elastic body 2A due to the first stage 51a moving in a rite side. At this time, the solutions X and Y which are contained in the injection chambers are pushed out in a right direction while the lower surface of the elastic body 2A is being squeezed by the upper surface of the first squeegee 41A under the state of predetermined pressurization due to the action of the spring 61A.

When the first stage 51A moves a predetermined distance and comes to the position of the second stage 52A, at the same time, the second stage 52A is driven and moves to the right side. Further, the first squeegee 41A moves along the lower surface of the elastic body 2A, simultaneously. In such case, the solution X and Y are also pushed out in the right direction and solutions X and Y react while the lower surface of the elastic body 2A is squeezed by the upper surface of the first squeegee 41A under a predetermined pressurization due to the action of the spring 61A. Furthermore in a similar manner, when the first stage 51A moves a predetermined distance and moves to the position where the third stage 53A was positioned, the first squeegee 41A moves along the lower surface of the elastic body 2A and the solution is pushed out in the right direction.

Meanwhile, whether the solution pool has occurred or not is detected by the detection sensor 71A and 72A during the series of the above described solution transfer operation, and the movements of the first to third stages 51A to 53A are stopped when the solution pool has occurred. The stage at the place where the solution pool has occurred departs from the cartridge 3A and moves to the original position by a process which is omitted from the drawing. Then, the stage moves in the solution transfer direction again to carryout retransfer of the solution by the squeegee. At this time, other squeegees hold down the upper surface of the elastic body 2A.

As described above, the chemical reaction apparatus 100A comprises the plurality of squeegees 41A to 42A and the plurality of stages 51A to 53A which move freely and independently from one another while contacting the upper surface of the elastic body 2A, and the detection sensors 71A and 72A which detect the state of solution pool occurred in the flow passages or the chambers. When the solution pool occurs, the solution pool is automatically detected by the detection sensor 71A and 72A, and the retransfer of the solution is carried out by moving the squeegee 42A on the upper surface of the elastic body 2A at the place where the solution pool is detected. Therefore, the solution transfer error and the fictitious transfer can be prevented, and the solutions can be surely transferred to carry out the reaction. As a result, a highly reliable solution transfer can be realized. Further, it is efficient because the detection of solution pool and the retransfer of the solution are carried out automatically and not manually.

Moreover, the springs 61A to 63A are respectively provided between the first to third squeegees 41A to 43A and the first to third stages 51A to 53A. Therefore, the flexure and irregularity of the elastic body 2A are absorbed by the springs 61A to 63A and each squeegees 41A to 43A can be pressed on to the lower surface of the elastic body 2A with a proper pressure and move even in a case where the force adjustment of the pressurized surface is uneven due to the flexure, irregularity, and thickness unevenness of the elastic body 2A. Thus, in this respect, the highly reliable solution transfer can also be realized.

The present invention is not limited to the above described embodiments, and can be arbitrarily changed within the gist of the present invention.

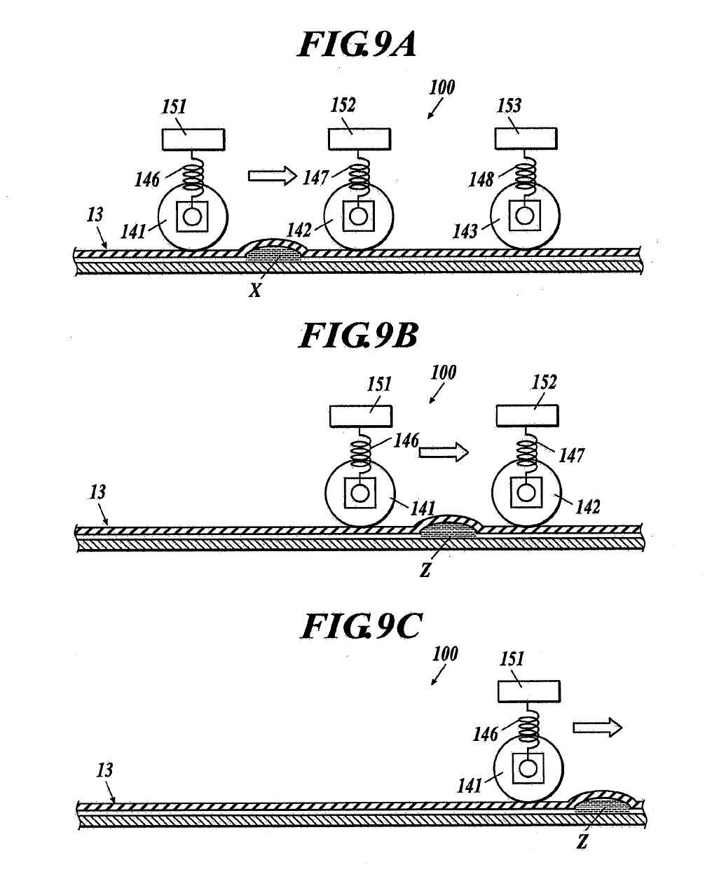

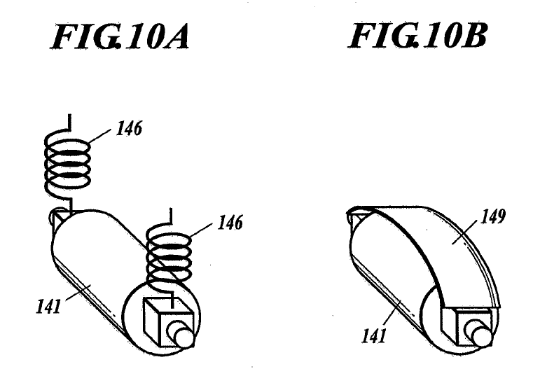

For example, in the above described first and second embodiments, the squeegees 41 to 43 and 41A to 43A are used as the liquid transfer units. However, rollers 141 to 143 formed in circular shape in side view which are shown in FIG. 9 may be used besides the squeegees. Here, FIGS. 9A to 9C are sectional side views showing operations of first to third rollers 141 to 143, and FIG. 10A is a perspective view of an outer appearance of the first roller 141. In the drawing, the cartridge 13 is the same as the cartridge 3 of the first embodiment, and springs 146 to 148 are attached at both ends of a roller shaft. Further, plate spring 149 which extends along the longitudinal direction of the roller 141 as shown in FIG. 10B may be used as the springs 146 to 148 beside the coiled springs.

Moreover, as a unit to press the squeegees 41 to 43 and 41A to 43A and the rollers 141 to 143 on the upper surface of the elastic body 2 and 2A by a predetermined pressurization, rubber or elastomer having elasticity may be used other than the springs 61 to 63, 61A to 63A, and 146 to 148. Further, the above unit may be constructed so that the squeegees 41 to 43 and 41A to 43A and the rollers 141 to 143 can be pressed on to the elastic body 2 and 2A optimally and automatically by the predetermined pressurization by a member for generating an air pressure, a member for generating a magnetic force, a piezoelectric element having a pressure sensor, or the like. Furthermore, the pressurization force may be measured by the pressure sensor, and the applied voltage to the air pressure, the magnetic force, and the piezoelectric element may be changed. A spring or an elastic body is provided to the pressing members such as the squeegees 41 to 43 and 41A to 43A and the rollers 141 to 143. However, a spring of an elastic body may be provided to the top plate such as 81A which supports the cartridge 3A, for example.

Moreover, the number of squeegees 41 to 43, 41A to 43A and the rollers 141 to 143 may be arbitrarily changed as long as the number is plural. The number of stages 51 to 53, 51A to 53A may also be changed. Here, in the above described first embodiment, it is constructed so that each squeegee can move independently by providing one stage for one squeegee; the first stage 51 is provided for the first squeegee 41; the second stage 52 is provided for the second squeegee 42; and the third stage 53 is provided for the third squeegee 43. However, for example, one stage may be commonly used as a stage for driving two of the three squeegees, and the remaining one squeegee may be driven by an independent stage as long as it is constructed so that the plurality of squeegees can move independently. Alternatively, it can be constructed only by a spring, and the spring may be only one.

The shapes, the number, and the like of the plurality of chambers 21 to 25 and the flow passages 26a, 26b, 27a, and 27b formed in the cartridge 3, 3A are not limited to that of the above description.

The entire disclosures of Japanese Patent Application No. 2006-225502 filed on Aug. 22, 2006 including specification, claims, drawings and abstract thereof are incorporated herein by reference in its entirety.

What is claimed is:

1. A chemical reaction apparatus in which a chemical reaction of solutions is carried out by transferring the solutions, comprising:
moving units to seal or move the solutions in a flow passage or a plurality of chambers of a container by applying an external force to an elastic body of the container by moving on a surface of the elastic body while the moving units contact with the surface of the elastic body, the moving units being movable independently from each other with respect to a cartridge including the container which is at least partially structured with the elastic body, the container including the plurality of chambers to contain the solutions and the flow passage to connect the plurality of chambers, and
a detection unit to detect a state of solution pool in the flow passage or the chamber.

2. The chemical reaction apparatus as claimed in claim 1, further comprising:
a control unit to drive the moving units and transfer the solutions by moving the moving unit again on the surface of the elastic body where the state of solution pool is detected when the state of solution pool is detected by the detection unit.

3. The chemical reaction apparatus as claimed in claim 2, wherein the detection unit comprises
a light emitting unit to emit a light to the solutions in the plurality of chambers or the flow passage, and
a light receiving unit to receive a reflection light reflected from the solutions by emitting the light, a transmitted light, or a fluorescent.

4. The chemical reaction apparatus as claimed in claim 2, wherein the detection unit comprises
a light emitting unit to emit a light to the solutions in the plurality of chambers or the flow passage, and
an image detection unit to detect an image of the solutions, which is formed by emitting the light as an image signal.

5. The chemical reaction apparatus as claimed in claim 4 wherein
a light guide path which communicates with inside of the plurality of chambers or the flow passage is formed in the cartridge, and
the light emitted by the light emitting unit is detected by the image detection unit after passing through the light guide path and being introduced in the plurality of chambers or the flow passage.

6. The chemical reaction apparatus as claimed in claim 2, wherein the detection unit comprises
an ultrasonic oscillation unit to oscillate an ultrasonic wave to the solutions in the plurality of chambers or the flow passage, and
an ultrasonic receiving unit to receive the ultrasonic wave which is oscillated from the solutions due to the ultrasonic wave being oscillated by the ultrasonic oscillation unit.
